(19) United States
(12) Patent Application Publication
(10) Pub. No.: US 2023/0385725 A1
(43) Pub. Date: Nov. 30, 2023

(54) WORK ASSISTANCE SYSTEM USING THE IMAGE RECOGNITION-BASED VIRTUAL OBJECT REGISTRATION METHOD IN THE INDUSTRIAL FIELD

(71) Applicant: EXTRIPLE Co., Ltd., Changwon-si (KR)

(72) Inventor: Jin song ROH, Changwon-si (KR)

(73) Assignee: EXTRIPLE Co., Ltd., Changwon-si (KR)

(21) Appl. No.: 17/826,146

(22) Filed: May 26, 2022

(30) Foreign Application Priority Data
May 25, 2022 (KR) 10-2022-0064059

(51) Int. Cl. G06Q 10/06; G06T 7/30; H04N 7/18; G06T 17/05; G06V 20/52; H04N 5/232; G06T 7/11; G01W 1/10

(52) U.S. Cl. CPC G06Q 10/063114; G06T 7/30; H04N 7/183; G06T 17/05; G06V 20/52; H04N 5/23222; G06T 7/11; G01W 1/10; G06T 2207/20021; G06T 2200/08; G06T 2207/30204; G06T 2207/30196; G06T 2210/04

(57) ABSTRACT

A work assistance system includes: a worker terminal that shoots construction work image of a worker wearing a preset worker terminal, displays worker location information, and transmits and receives notification data and voice data; a work data provider that provides work data of at least one of work manual, precautions, image playback of similar work performance, work order, and work method to the worker terminal; a construction area generator that creates a 3D modeling image of the construction area; a work determiner that determines whether to proceed with the next work in response to the 3D image; a monitoring unit that collects and monitors real-time images from the preset worker terminal; a coordinate allocator that divides the construction area within the industrial field, allocates individual coordinates, and displays it on the preset worker terminal; and an object shape display that uses the individual coordinates allocated by the coordinate allocator.

### TECHNICAL FIELD

The present invention relates to a work assistance system using the image recognition-based virtual object registration method in the industrial field, more specifically to a system that assists systematic building construction by using a preset worker terminal to receive an industrial site image from a building construction worker and mapping it to a 3D image and conveying work progress, work execution time, work method, and whether work is performed.

### BACKGROUND ART

“Building”, a representative result of industrial settings, is a generic term for structures to accommodate people, goods, and mechanical equipment, which can be provided based on stability by taking materials most suitable for the purpose of use and the surrounding environment in the most reasonable form, and is sometimes referred to as a space art.

Basically, buildings are to provide people with stable shelters while minimizing the impact on the indoor environment from external weather environments such as rain, wind, and cold, but nowadays they are gaining more importance in the economic sense as real estate that not only provides a comfortable living environment but also has economic value.

In line with this social phenomenon, the demand for buildings is concentrated on the basis of their economic value, but since there is not enough land to meet all of the nation's demand for buildings, the value of buildings is increasing even now and buildings are being built higher to accommodate a larger number of floors in a limited building area.

Meanwhile, as buildings get taller, they are increasingly required to be robust enough to absorb and withstand loads and shocks from the external weather environment, but due to ground erosion, cracks and even collapse caused by poor construction, many people were injured or killed and the damage was particularly large for high-rise buildings.

In order to prevent such building accidents, many experts are preparing solutions using various materials and construction methods in the construction process of buildings. However, in many cases workers participating in the actual construction do not follow the manual, and even on-site managers are insufficient compared to the workers, so there are many difficulties in conducting management supervision and quality control.

Therefore, it is necessary to study the work assistance system in the industrial field that continuously checks and supports the construction status of buildings by collecting work images from field workers wearing preset worker terminals, mapping them to 3D images according to work time sequence in the same area, sharing the work time and work situation, and providing workers with the next work instruction, the correct way to work, and an invisible area for the work being performed.

### PRIOR ART DOCUMENTS

### Patent Documents

Korean Patent Publication No. 10-1798165

### SUMMARY OF INVENTION

### Problems to be Solved

The present invention aims to collect the visual field images of each worker in the industrial field, and thus help to understand in detail the construction (work) situation in the industrial field, occurring at a plurality of points.

It also aims to provide various information related to operation, such as work details, work precautions, and similar work images, to the preset worker terminals worn by workers, thereby inducing accurate and safe operation of workers.

In addition, by providing data transmission/reception and voice transmission/reception functions between workers or between workers and managers using preset worker terminals worn by workers, it aims to quickly deliver all notifications, emergencies and disasters.

In addition, as building construction in the industrial field goes on with reinforcing bars, drainage pipes, gas pipes progresses, and etc., by modeling an area invisible to the naked eye and displaying it on the screen of the preset worker terminals, it aims to record information related to the progress of construction work and work performance.

### Solution to Problems

A work assistance system using the image recognition-based virtual object registration method in the industrial field according to an embodiment of the present invention may comprise: a worker terminal that shoots construction work image of a worker wearing a preset worker terminal, displays worker location information, and transmits and receives notification data and voice data; a work data provider that provides work data of at least one of work manual, precautions, image playback of similar work performance, work order, and work method to the worker terminal; a construction area generator that creates a 3D modeling image of the construction area in the industrial field using building construction images collected from the worker terminal; a work determiner that determines whether to proceed with the next work in response to the 3D image and transmits it to the worker terminal; a monitoring unit that collects and monitors real-time images from the preset worker terminal and transmits a rescue request when a preset abnormal motion is detected; a coordinate allocator that divides the construction area within the industrial field, allocates individual coordinates corresponding to the divided construction area, and displays it on the preset worker terminal; and an object shape display that uses the individual coordinates allocated by the coordinate allocator and displays the outer shape of the construction area in the invisible area on the preset user terminal.

In addition, the worker terminal displays words of guidance to guide the placement of marker on the preset worker terminal before shooting the construction work images, and receives at least one modeling image of electric cable, reinforcing bar, concrete pouring area, drainage pipe, water pipe, gas pipe, and heat insulating material, generated by the construction area generator, and thereby may display the modeling image corresponding to the current image of the preset worker terminal on the screen.

In addition, the construction area generator may comprise: a construction area divider that divides the construction area based on the marker in the construction work image in the industrial field collected from the worker terminal; a modeling unit that generates an image modeling the divided construction area as a 3D image; and a construction area updater that matches the image collected from the worker terminal and the image modeled into the 3D image with the real space, and displays the updated modeling image in chronological order on the worker terminal.

In addition, the work determiner may comprise: an work decision unit that determines the timing of the next work in response to the construction area modeled by the construction area generator; an work notifier that delivers the next work start date, work details, and work notes to the worker terminal when the next work time is determined; an environmental data transmitter that collects meteorological data including temperature, humidity, air volume, fine dust concentration, ultraviolet rays, sunlight, precipitation and snowfall on the date when the next work time is determined and transmits it to the monitoring unit; and an work order unit that transmits whether the next work is in progress to the worker terminal in response to the work availability signal sent from the monitoring unit.

In addition, the monitoring unit is interlocked with the preset worker terminal to deliver notification of work interruption, break time, work cleanup time, patient occurrence, emergency situation, and disaster occurrence to the worker terminal, and in response to a preset request received from the worker terminal, may request a review from a quality manager or a construction expert, report to a rescue organization, or relay a call connection with the on-site manager.

### Beneficial Effects

According to the present invention, by collecting the visual field image of each worker in the industrial field, it is possible to grasp in detail the construction (work) situation in the industrial field occurring at a plurality of points.

In addition, it is possible to induce accurate and safe work of workers by providing various information related to the work, such as work details, work precautions, and similar work images, to the preset worker terminals worn by workers.

In addition, by providing data and voice transmission and reception functions between workers or between workers and managers using preset worker terminals worn by workers, it is possible to quickly deliver all notifications, emergency and disaster situations.

In addition, by modeling an area invisible to the naked eye and displaying it on the screen of the preset worker terminal as construction work in industrial field such as reinforcing bars, drainage pipes, and gas pipes progresses, it is possible to record information related to the progress of construction work and work performance.

### BRIEF DESCRIPTION OF DRAWINGS

FIG. 1 is a block diagram of a work assistance system using the image recognition-based virtual object registration method in the industrial field according to an embodiment of the present invention.

FIG. 2 is an intermediate block diagram of a construction area generator in a work assistance system using the image recognition-based virtual object registration method in the industrial field according to an embodiment of the present invention.

FIG. 3 is an intermediate block diagram of an work determiner in a work assistance system using the image recognition-based virtual object registration method in the industrial field according to an embodiment of the present invention.

FIG. 4 is a diagram showing that, in a work assistance system using the image recognition-based virtual object registration method in the industrial field, according to an embodiment of the present invention, coordinates are allocated to the construction area and displayed as points, lines and planes in the worker terminal.

FIG. 5 is a diagram showing that, in a work assistance system using the image recognition-based virtual object registration method in the industrial field according to an embodiment of the present invention, the assigned coordinates are used to display the object shape in the invisible construction area.

### BEST MODE FOR CARRYING OUT THE INVENTION

Specific details including the problems to be solved, the solution to problems, and the beneficial effects of the present invention as described above are included in the embodiments and drawings to be described below. Advantages and features of the present invention and methods of achieving them will become apparent with reference to the embodiments described below in detail in conjunction with the accompanying drawings.

The scope of the present invention is not limited to the embodiments described below, and various modifications may be made by those of ordinary skill in the art without departing from the technical gist of the present invention.

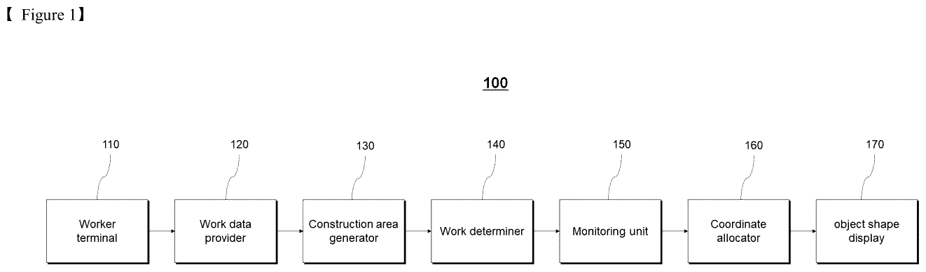

Hereinafter, a work assistance system using the image recognition-based virtual object registration method in the industrial field of the present invention will be described in detail with reference to the accompanying FIGS. 1 to 5.

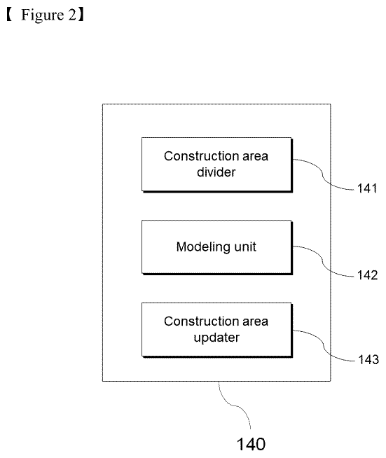

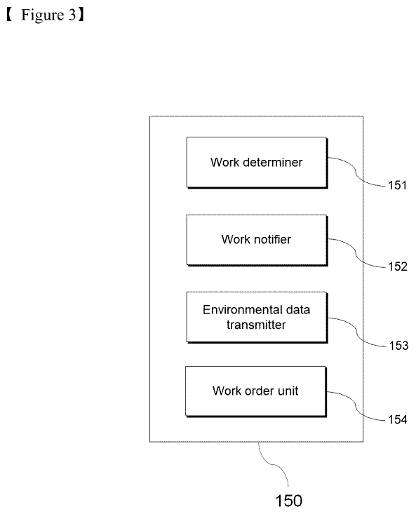

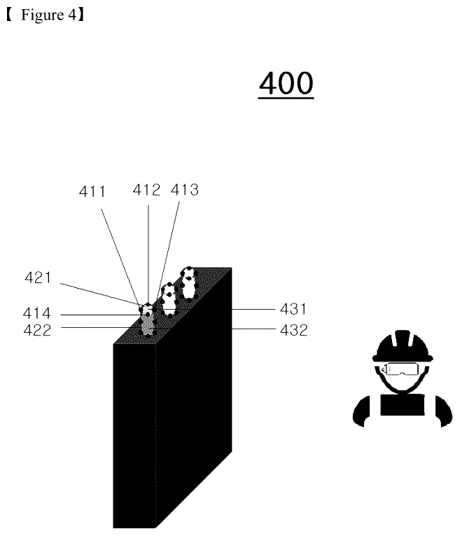

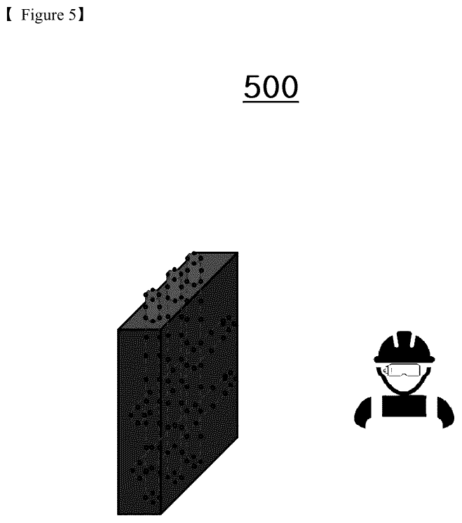

First of all, FIG. 1 is a block diagram of a work assistance system using the image recognition-based virtual object registration method in the industrial field according to an embodiment of the present invention; FIG. 2 is an intermediate block diagram of a construction area generator in a work assistance system using the image recognition-based virtual object registration method in the industrial field according to an embodiment of the present invention; FIG. 3 is an intermediate block diagram of an work determiner in a work assistance system using the image recognition-based virtual object registration method in the industrial field according to an embodiment of the present invention; FIG. 4 is a diagram showing that, in a work assistance system using the image recognition-based virtual object registration method in the industrial field, according to an embodiment of the present invention, coordinates are allocated to the construction area and displayed as points, lines and planes in the worker terminal; and FIG. 5 is a diagram showing that, in a work assistance system using the image recognition-based virtual object registration method in the industrial field according to an embodiment of the present invention, the assigned coordinates are used to display the object shape in the invisible construction area.

Referring to FIG. 1, a work assistance system using the image recognition-based virtual object registration method in the industrial field according to an embodiment of the present invention may comprise a worker terminal (110), a work data provider (120), a construction area generator (130), a work determiner (140), a worker monitoring unit (150), a coordinate allocator (160), and an object shape display (170).

The worker terminal (110) may perform shooting of construction work images in the industrial field of a worker wearing a preset worker terminal, display of worker's location information, and transmission/reception of notification data and voice data.

Here, the preset worker terminal means a device such as a smartphone, a tablet PC, a smart glass, and a head mounted display (HMD) that can communicate with other user terminals using image shooting and wireless communication, and in particular, terminals mounted on a body part close to the user's eyes or face, such as HMD (Head Mounted Display) and smart glasses, are most preferred.

In addition, the worker terminal (110) is provided at a position that allows to capture the worker's front view, such as the worker's eyes or face, and to shoot images of construction work and collect image data when the worker performs building construction work in the industrial field while wearing the worker terminal.

Furthermore, by using the GPS module built in the worker terminal to further collect worker's location information at the time of image shooting, it is possible to classify and store the work performance images according to location information.

Also, in the work tab provided in the screen of the worker terminal, the worker terminal (110) may select and input the same or similar work as the name of the work to be performed by the worker.

As an example, if a rebar distribution work to evenly arrange foundation rebars is scheduled in the industrial field where the worker constructs a building, the worker can tag the “foundation rebar distribution work” by selecting the “foundation rebar distribution” from the work tab on the screen of the worker terminal (110) and shooting work performance images of the worker. At this time, the location information at the time the work performance image was recorded can be simultaneously recorded to store the worker's location and work performance information.

Meanwhile, the worker terminal (110) may output a notification and a voice message transmitted from the work determiner (140) and the monitoring unit (150), and display a text phrase.

In addition, the worker terminal (110) provides a real-time voice data transmission/reception function using wireless communication between workers belonging to a team in which two or more workers perform the same task, and assists communication between team members located at a distance in team work, thereby improving the accuracy and efficiency of work performance.

Meanwhile, the worker terminal (110) displays words of guidance to guide the placement of a marker, which is a black and white pattern for recognition used for image recognition before shooting of construction work, on the worker terminal to extract relative coordinates in the image and take images by reflecting reference points to implement virtual information.

On the other hand, the worker terminal (110) may receive the modeling image of at least one of an electric cable, reinforcing bar, concrete pouring area, drainage pipe, water pipe, gas pipe and insulation material corresponding to the construction area generated by the construction area generator (130) and display the modeling image corresponding to the current image of the worker terminal on the screen.

As an example, when a worker performs a plastering work while facility construction including sewage, electricity and water facility work is in progress at the construction site, the worker terminal may receive and display the image, modeled by the construction area generator (130), of the pipe invisible to the naked eye.

Moreover, the plastering worker can check the progress of the plumbing work uploaded by the plumbing worker and the location to be constructed in the future to avoid overlapping areas.

The work data provider (120) may provide the worker terminal (110) with work data of at least one of a work manual, precautions, image reproduction of similar work performance, work order, and work method.

Here, the work manual may mean to provide image and text data for the work content selected by the worker from the worker terminal (110) and how to use the work tool to the worker terminal.

In addition, the previous similar work images are provided to the worker terminal in response to the work currently selected by the worker, thereby reducing the possibility of the worker's mistakes and erroneous operation and promoting efficient work performance.

The construction area generator (130) may generate a 3D modeling image of a building structure in the construction area based on the building construction images collected by the worker terminal (110).

Here, the construction area generator (130) will be described in more detail with reference to FIG. 2.

Referring to FIG. 2, the construction area generator (130) may comprise a construction area divider (131), a modeling unit (132), and a construction area updater (133).

The construction area divider (131) may divide the construction area based on the marker in the construction work image in the industrial field, collected from the worker terminal.

More specifically, the construction area divider (131) may determine the location of marker in the image taken using the worker terminal (110) as the center of the construction area, and divide the construction area by a distance set by a worker from the center of the construction area.

For example, when working on the floor with a square area of 2.5 m in width and 2.5 m in height, the worker may place markers at the center of the square area and the points corresponding to the four vertices, input a distance value of 2.5 m from the center, and then shoot images using the worker terminal (110). Thereafter, the construction area divider (131) may divide only the square area corresponding to the distance value of 2.5 M input by the worker from the marker position into the construction area.

At this time, the location information of the worker may be further included and stored in the image divided into the construction area.

The modeling unit (132) may generate a modeling image by modeling the divided construction area as a 3D image.

More specifically, the modeling unit (132) performs modeling to create and map a 3D virtual space using the work image with markers, captured by the worker terminal (110), and further reflect the area changed before and after the construction from the area divided by the construction area divider (131) in the virtual space, thereby creating a modeling image.

As an example, if the worker placed the marker before work at the building construction site and performed the foundation rebar distribution, the modeling unit (132) may create a modeling image reflecting the distributed foundation rebars for the area where changes occurred due to foundation rebar distribution from the images at the start and end of the worker's previous work.

In other words, if 10 rebars are distributed at 1 m intervals at the end of the work, based on the starting point of the foundation rebar distribution work, that is, 09 o'clock the day before when no rebars have been distributed, the modeling unit (132) may perform modeling work so that 10 rebars are distributed at intervals of 1 m.

The construction area updater (133) may match the image collected from the worker terminal (110) and the image modeled as a 3D image with the real space, and display the modeling image updated in time sequence on the worker terminal.

That is, by using the work image collected from the worker terminal (110), it may update the changing construction area modeling image with the image from the start of the work to the latest time in response to the construction area in the image that is continuously collected and updated in the worker terminal (110) after modeling the divided construction area in the modeling unit (132).

As an example, if 10 rebars were distributed at 1 m intervals two days ago through the modeling unit (132) in the industrial field for constructing buildings, a modeling image in which the 10 rebars were rebar distributed at 1 m intervals a day before may be updated in the worker terminal (110). After that, when a modeling image in which 10 rebars are further distributed at intervals of 1 m in a grid form is added in the last image of the work, the construction area updater (133) may update the work image to reflect the modeling in which 20 rebars are distributed in a grid shape with an interval of 1 m today and display it on the worker terminal.

The work determiner (140) may determine whether to proceed with the next work in response to the current visual field image and 3D image displayed on the worker terminal and the work details selected by the worker and transmit it to the worker terminal (110).

Here, the work determiner (140) can be described in more detail with reference to FIG. 3.

Referring to FIG. 3, the work determiner (140) may comprise a work decision unit (141), a work notifier (142), an environmental data transmitter (143), and a work order unit (144).

The work decision unit (141) may determine a time to start the next work in response to the construction area modeled by the construction area generator (130).

More specifically, it may determine when to start the next work by modeling the construction area in the construction area generator (130), and at the same time collecting additional work time information after the construction from the worker terminal in the construction area.

Here, the time to start the next work may be determined by giving priority to the next work time received from the terminal of the worker who performs the most priority work in the corresponding work area.

When the next work time is determined, the work notifier (142) may deliver the next work start date, work content, and work notes to the worker.

In this case, the worker may receive the contents delivered by the work notifier (142) through the worker terminal.

Also, the next work start date may mean a date determined by the work decision unit (141).

Meanwhile, the work content means work content data created by workers for each work area, and each worker can transmit work content data to a work manager at a preset cycle.

In this case, it is ideal that the worker transmits the work data to the work manager after the end of the daily work.

The environmental data transmitter (143) may collect meteorological data including temperature, humidity, air volume, fine dust concentration, ultraviolet light, sunlight, precipitation and snowfall on the date when the next work time is determined, and send it to the monitoring unit (150).

Here, the meteorological data, centered on the location where workers perform work in the industrial field, may be collected from a meteorological data collection specialized institution such as Meteorological Office.

This data may be used as a basis for determining whether to perform the next work by the work decision unit (141).

The work order unit (144) may transmit to the worker terminal (110) whether to perform the next work in response to a signal sent from the monitoring unit (150).

As an example, when a building construction work is in progress in the industrial field, and the construction area generator (130) creates a construction area by modeling the concrete pouring using the concrete pouring area information on Feb. 11, 2022, the image collected by the worker terminal (110) can be used to collect information: the first concrete pouring in A-13 area on the second floor of Building C on Feb. 11, 2022 at 14:00; and concrete pouring completed on Feb. 11, 2022 at 16:00 in A-13 area on the 2nd floor of Building C.

At this time, if the poured concrete is made of ordinary Portland cement, the work decision unit (141) may determine to perform the next work on Feb. 18, 2022, which is 7 days later, the average period of minimum wet curing.

Here, the work notifier (142) may transmit the date determined by the work decision unit (141), work details, and work notes to worker terminals in the construction area: “Feb. 18, 2022; insulation work; a safety helmet, safety shoes, and gaiters required when working; two people work in a group; beware of pinching and crushing accidents during insulation work”.

Meanwhile, when the environmental data transmitter (143) receives weather data that a cold wave below 0 degrees will last for 3 days from Feb. 14, 2022, which is before Feb. 18, 2022 determined by the work decision unit (141), the work order unit (144) may transmit to the work terminals a notification to postpone the work scheduled on Feb. 18, 2022 and to perform the next work on Feb. 21, 2022, which is calculated by adding the cold wave duration determined by the monitoring unit (150).

The monitoring unit (150) collects and monitors images from a worker terminal in real time, and when a preset abnormal motion is detected, may send a rescue request signal to a medical team or rescue organization in the industrial field.

Here, the preset abnormal motion includes blackout more than 30% of the screen for more than 3 seconds while the preset worker terminal is not normally terminated; generation of noise above 70 dB, which is the standard value; and no response or incorrect gesture within 3 to 5 minutes when a hand gesture is induced every 50 minutes to 1 hour to the video recording device of the preset worker terminals. When such abnormal motion is detected, a rescue request signal can be transmitted to the building construction medical team or rescue organization.

At this time, at first, the location and name of the worker whose abnormal motion is detected is transmitted to the preset terminal of the nearest other worker for a rescue request or a status check request. If the nearest other worker is more than 5 minutes away on foot, a rescue signal and location information are immediately transmitted to the building construction medical team, and if there is no response from the medical team within 5 minutes, a rescue signal can be immediately transmitted to the rescue organization.

In addition, the monitoring unit (150) may be interlocked with the worker terminal to send notifications of work interruption, break time, work cleanup time, patient occurrence, emergency situation occurrence, and disaster occurrence to the worker terminal (110).

Here, the break time and the work cleanup time may be notified at a predetermined time in response to the current time.

In addition, when a patient, an emergency, or a disaster occurs, a blinking red icon or full-screen blinking signal is transmitted on the screen of the worker terminal so that the worker can quickly recognize it.

Meanwhile, the monitoring unit (150) may relay a request for review by a quality manager and a construction expert, a report to a rescue organization, and a hotline with a site manager in response to a preset request received from the worker terminal (110).

As an example, when the worker makes a mistake during work at a building construction site, the worker terminal transmits the current image and situation to the monitoring unit (150), and the monitoring unit (150) performs a call connection with a quality expert or a construction expert capable of responding to the situation to induce a quick recovery by delivering to the worker a repair or re-construction method that the worker can perform.

In addition, in case of a safety accident in which rescue of the worker is required or other users are injured, the monitoring unit (150) is connected to a preset rescue organization, and may provide a real-time image through the worker terminal to the connected rescue organization.

At this time, if another worker arrives first and rescues the worker who has had a safety accident, first aid measures according to the current situation may be delivered from the person in charge of the rescue organization by voice through the call connection between the terminal of another worker in the rescue operation and the rescue organization.

Through this, rapid first aid may be induced for the worker who has had a safety accident.

The coordinate allocator (160) may subdivide the construction area divided by the construction area generator (130), allocate individual coordinates for the subdivided construction area, and display it on the worker terminal.

More specifically, the coordinate allocator (160) may designate a center (0, 0, 0) based on the marker in the construction area divided by the construction area divider (131) among the images taken in the view field of the worker terminal and allocate individual coordinates.

Here, the allocated individual coordinates mean three-axis coordinates consisting of the x-axis, the y-axis, and the z-axis, and individual coordinates may be allocated only to the divided construction area and modeling image.

In addition, the assigned individual coordinates may be displayed on the worker terminal and shared with terminals of workers who will perform other construction work later or supervise the construction.

The object shape display (170) may display the outer shape of the invisible area on the worker terminal by using the individual coordinates allocated by the coordinate allocator (160).

Here, the invisible area may mean an area in which a modeled object is located by being divided into the construction area, but only a part of the entire area is visible or the inside is covered by an external wall or concrete pouring during the work in the industrial field.

Here, the object shape display (170) will be described in more detail with reference to FIGS. 4 to 5.

Referring to FIGS. 4 to 5, when a part of the image modeled by the modeling unit (132) is captured in the object shape including the construction area in the image collected by the worker terminal, the object shape display (170) may allocate individual coordinates using the coordinate allocator (160).

Here, by matching the individual coordinates assigned to the modeling image and the construction area object collected by the construction area generator (130), the shape and structure of the object located inside the construction area may be displayed on the worker terminal, and individual coordinates may be further assigned.

For example, when a worker wearing a terminal performs a foundation concrete pouring after foundation rebar distribution at a building construction site, the preset worker terminal may be used to see and capture a part of the rebar in the view field of the concrete pouring point that is the target of the operation.

Here, when the rebars are determined to be construction area objects, the coordinate allocator (160) may assign individual coordinates, such as the 1st coordinate point (411), the 2nd coordinate point (412), the 3rd coordinate point (413) and the 4th coordinate point (414), to the rebars shown in the field of view of the worker terminal and display them on the screen of the preset worker terminal.

At this time, the object shape display (170) may connect the 1st coordinate point (411), the 2nd coordinate point (412), the 3rd coordinate point (413) and the 4th coordinate point (414) to draw a circle, and provide the displayed circle on the 1st coordinate plane (431), and display the 2nd coordinate plane (432) of the cylindrical shape by connecting the coordinate points assigned to some of the rebars in addition to the above-mentioned coordinate points.

From this, if the cylindrical object shape (rebar) consisting of coordinate points, coordinate lines, and coordinate planes on the rebars included in the view field of the current worker terminal and the construction area object modeled by the construction area generator (130) are determined to be a match, the object shape of the invisible region composed of the coordinate points, coordinate lines, and coordinate planes may be displayed on the worker terminal based on the modeling corresponding to the object shape (rebar).

Meanwhile, when the worker proceeds with concrete pouring on the object shape (rebar) marked with the object shape, the construction area including the construction start date, construction participants, construction details, and individual coordinates may be recorded and shared so that other workers refer to it in the construction to be carried out in the same or nearby construction area.

Through the process as described above, the work assistance system using the image recognition-based virtual object registration method in the industrial field may use preset worker terminals provided for each worker to shoot construction work images at multiple points in the industrial field and monitor work progress by collecting work date, person in charge of work, work location, etc., and may use the work images to model the construction area in chronological order, and record workers and work date and time corresponding to the construction area so that the work progress of the building can be seen at a glance.

According to an embodiment of the present invention, individual visual field images of workers in the industrial field may be collected so that the construction (work) situation in the industrial field occurring at a plurality of points can be grasped in detail.

In addition, by providing various information related to the work, such as work details, work notes, and similar work images, to preset worker terminals worn by workers, accurate and safe works by workers can be induced.

Moreover, by using the preset worker terminals worn by workers that provide data and voice transmission/reception functions between workers or between workers and managers, all notifications, emergency situations, and disasters can be delivered quickly.

In addition, when a building construction work using rebar, drainage pipe, gas pipe, etc. is in progress in the industrial field, by modeling an area invisible to the naked eye and displaying it on the screen of the preset worker terminal, information related to the progress of building construction work and work performance can be recorded as data.

As described above, the present invention has been described with reference to the limited embodiments and drawings, but it is not limited to the above-described embodiments, and various modifications and variations may be made by those skilled in the art to which the present invention pertains. Accordingly, the spirit of the present invention should be understood only by the claims set forth below, and all equivalents or equivalent modifications thereof will fall within the scope of the spirit of the present invention.

### DESCRIPTION OF SIGNS

100: a work assistance system using the image recognition-based virtual object registration method in the industrial field
110: worker terminal
120: work data provider
130: construction area generator
131: construction area divider
132: modeling unit
133: construction area updater
140: work determiner
141: work decision unit
142: work notifier
143: environmental data transmitter
144: work order unit
150: monitoring unit
160: coordinate allocator
170: object shape display
411: 1st coordinate point
412: 2nd coordinate point
413: 3rd coordinate point
414: 4th coordinate point
421: 1st coordinate line
422: 2nd coordinate line
431: 1st coordinate plane
432: 2nd coordinate plane

1. A work assistance system using the image recognition-based virtual object registration method in the industrial field that comprises:
a worker terminal that shoots construction work image of a worker wearing a preset worker terminal, displays worker location information, and transmits and receives notification data and voice data;
a work data provider that provides work data of at least one of work manual, precautions, image playback of similar work performance, work order, and work method to the worker terminal;
a construction area generator that creates a 3D modeling image of the construction area in the industrial field using building construction images collected from the worker terminal;
a work determiner that determines whether to proceed with the next work in response to the 3D image and transmits it to the worker terminal;
a monitoring unit that collects and monitors real-time images from the preset worker terminal and transmits a rescue request when a preset abnormal motion is detected;
a coordinate allocator that divides the construction area within the industrial field, allocates individual coordinates corresponding to the divided construction area, and displays it on the preset worker terminal; and
an object shape display that uses the individual coordinates allocated by the coordinate allocator and displays the outer shape of the construction area in the invisible area on the preset user terminal.

2. With respect to claim 1,
a work assistance system using the image recognition-based virtual object registration method in the industrial field,
wherein the worker terminal displays words of guidance to guide the placement of marker on the preset worker terminal before shooting the construction work images, and
receives at least one modeling image of electric cable, reinforcing bar, concrete pouring area, drainage pipe, water pipe, gas pipe, and heat insulating material, generated by the construction area generator, and
thereby may display the modeling image corresponding to the current image of the preset worker terminal on the screen.

3. With respect to claim 1,
a work assistance system using the image recognition-based virtual object registration method in the industrial field,
wherein the construction area generator may comprise:
a construction area divider that divides the construction area based on the marker in the construction work image in the industrial field collected from the worker terminal;
a modeling unit that generates an image modeling the divided construction area as a 3D image; and
a construction area updater that matches the image collected from the worker terminal and the image modeled into the 3D image with the real space, and displays the updated modeling image in chronological order on the worker terminal.

4. With respect to claim 1,
a work assistance system using the image recognition-based virtual object registration method in the industrial field,
wherein the work determiner may comprise:
an work decision unit that determines the timing of the next work in response to the construction area modeled by the construction area generator;
an work notifier that delivers the next work start date, work details, and work notes to the worker terminal when the next work time is determined;
an environmental data transmitter that collects meteorological data including temperature, humidity, air volume, fine dust concentration, ultraviolet rays, sunlight, precipitation and snowfall on the date when the next work time is determined and transmits it to the monitoring unit; and
an work order unit that transmits whether the next work is in progress to the worker terminal in response to the work availability signal sent from the monitoring unit.

5. With respect to claim 1,
a work assistance system using the image recognition-based virtual object registration method in the industrial field,
wherein the monitoring unit is interlocked with the preset worker terminal to deliver notifications of work interruption, break time, work cleanup time, patient occurrence, emergency situation, and disaster occurrence to the worker terminal, and
in response to a preset request received from the worker terminal, may request a review from a quality manager or a construction expert, report to a rescue organization, or relay a call connection with the on-site manager.
